(19) United States
(12) Patent Application Publication
(10) Pub. No.: US 2004/0258215 A1
(43) Pub. Date: Dec. 23, 2004

(54) Method for sending a short message from a wireline phone

(76) Inventors: Nicholas Michael DeVito, Naperville, IL (US); Eric Edward Kampmeier, Sycamore, IL (US); Thomas J. Loos, Lisle, IL (US); Simon S. Ou, Naperville, IL (US)

Correspondence Address: Docket Administration (Room 3J-219), Lucent Technologies Inc., 101 Crawfords Corner Road, Holmdel, NJ, 07733-3030, US

(21) Appl. No.: 10/600,077

(22) Filed: Jun. 20, 2003

(51) Int. Cl. H04M 1/64; H04M 3/42

(52) U.S. Cl. 379/88.11

(57) ABSTRACT

The present invention provides a method for sending and receiving text messages using the wireline telephone network, common control switching arrangements, and commonly available equipment such as DTMF telephones and caller-ID devices. One wireline Short Message Service (SMS) application is a broadcast message system that can update parents of students who attend a school. Further applications include user-controlled lists, dynamic lists, Public Service Announcements, and news services. Call signaling methods are utilized to alert the receiving station of an incoming message and to deliver the message. Alerting options include using suppressed ringing to deliver a message without ringing the line as part of a calling name parameter during normal alerting, ISDN D-channel (out of band) message(s), or using normal ringing and sending the FSK after answer on an adjunct CPE or computer-only line. Additionally, a text message could be scheduled at a targeted date and time for delivery.

### FIELD OF THE INVENTION

The present invention relates generally to communication systems, and more particularly to a method for sending and receiving text messages from a wireline phone in a communication system.

### BACKGROUND OF THE INVENTION

Wireline Short Message Service (SMS) provides one-to-one or one-to-many (broadcast) short text message service to wireline subscriber units, and can be extended to interwork with wireless SMS. SMS appears to subscriber units as a text message on the caller ID screen. In a wireline system, the caller ID screen will be part of an external CPE. SMS messages can be a short application, less than or equal to fifteen characters, or a long application, up to about 255 characters. There are many applications for both short and long message services.

Although wireless SMS has become popular, there are many shortcomings to this service. First, wireless SMS can only be sent between wireless users, and many still do not have wireless phones. In addition, most wireless phone numbers are not published. Still further, most wireless phones are not always turned on.

Therefore, a need exists for a method and communication system that allows a user to send a short message from a wireline phone.

### BRIEF SUMMARY OF THE INVENTION

The present invention provides a method for sending and receiving text messages using the wire-line telephone network, common control switching arrangements, and commonly available CPE such as DTMF telephones and caller-ID devices.

One wireline SMS application is a broadcast message system that can update parents of students who attend a school. For example, the school can send a brief text message to all parents' phones to alert them that school has been canceled. In this embodiment, the school sends a short text message to a list of telephone numbers, which can be either wireless or wireline phones.

Further embodiments for the present invention include user-controlled lists, such as those for soccer teams, clubs, and other organizations. In addition, the present invention provides for dynamic lists, such as for a baby announcement, Public Service Announcements, such as a tornado watch, news services, such as periodic stock quotes or weather. Still further, Internet Service Provider can provide interworking, such as alerting a user when a new email arrives, law enforcement purposes, such as All Points Bulletins (APBs), and direct marketing implementations. The Federal Trade Commission (FTC) is preparing to limit unsolicited telemarketing, so the present invention would allow customers to “tune in” to streams of marketing information categorized by type, such as “channels” of interest.

The present invention modifies existing Caller ID protocol to provide short text messages in MDMF format using low-speed (1200 bps) analog data transmission. A single MDMF message supports up to 255 characters. A switch needs to interpret incoming DTMF from an originating SMS subscriber unit as a request to send a text message to one or more subscriber lines. Alternatively, for bulk data delivery, a more sophisticated information provider could originate message data to the switch using higher bandwidth methods such as ISDN. The switch needs to send outgoing SMS text to terminating wireline SMS subscriber units with the appropriate display technology, which is FSK for traditional analog lines and ISDN information elements for digital ISDN phones. For use with wireless phones, the originating wireline switch would formulate a Wireless SMS request message and send it via the SS7 network to the wireless subscriber's Mobile SMS server. The SMS server would then deliver the text message to the subscriber.

The present invention utilizes call processing signaling methods to alert the receiving station of an incoming message and subsequently to deliver the message. Text messages can be FSK transmission, ISDN information elements, or a voice announcement. For example, a text-to-speech conversion may be performed by the switching system. Alerting options include using suppressed ringing to deliver message without ringing the line, delivering the message as part of a calling name parameter during normal alerting, ISDN D-channel (out of band) message(s), or using normal ringing and sending the FSK after answer on an adjunct CPE or computer-only line. The suppressed ringing would preferably integrate a CPE wakeup tone transmitted by the switch. The normal ringing option works with existing modem-type devices. Additionally, a text message could be scheduled at a targeted date and time for delivery.

### BRIEF DESCRIPTION OF THE SEVERAL VIEWS OF THE DRAWINGS

FIG. 1 depicts a plurality of subscriber units connected to a wireline communication system in accordance with an exemplary embodiment of the present invention.

FIG. 2 depicts a call flow diagram in which a subscriber unit wants to send a message to a second subscriber unit.

FIG. 3 depicts a call flow diagram in which a subscriber unit wants to send a message to a subscriber list.

FIG. 4 depicts a call flow diagram in which an originating subscriber unit connected to a first switch sends a message to a subscriber list that includes a first subscriber unit connected to the first switch and a second subscriber unit connected to a second switch.

FIG. 5 depicts a call flow diagram in which a subscriber unit wants to send a message to a subscriber list by utilizing a gatekeeper database that provides storage and retrieval of the subscriber list.

FIG. 6 depicts a call flow diagram in which an originating subscriber unit connected to a first switch sends a message to a subscriber list stored by a gatekeeper database and includes a first subscriber unit connected to the first switch and a second subscriber unit connected to a second switch.

FIG. 7 depicts a call flow diagram for a method of providing near real-time filtered information delivery.

FIG. 8 depicts a call flow diagram in which a subscriber unit wants to send a broadcast message to all subscriber units that subscribe to a Wireline SMS Terminating feature on a switch.

### DETAILED DESCRIPTION OF THE INVENTION

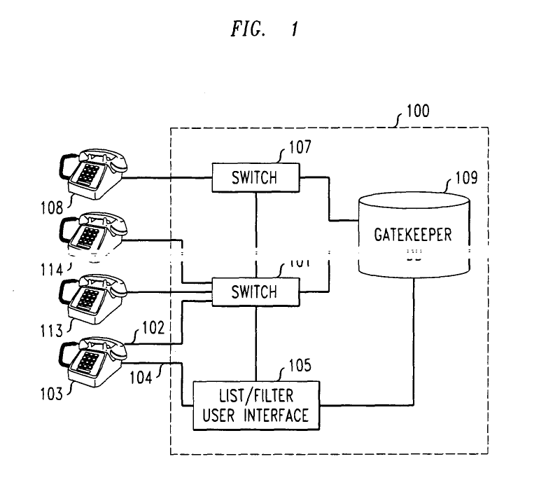

FIG. 1 depicts a plurality of subscriber units connected to a wireline communication system 100 in accordance with an exemplary embodiment of the present invention. Wireline communication system 100 preferably includes switch 101, list/filter user interface 105, switch 107, and gatekeeper database 109. Subscriber unit 103 is connected to wireline communication system 100 through switch 101 via interface 102. Subscriber unit 103 is also connected to list/filter user interface 105 via interface 104.

Switch 101 provides a wireline SMS channel 102 to subscriber unit 103. In a preferred embodiment, switch 101 is a 5ESS Switch provided by LUCENT TECHNOLOGIES INC. of Murray Hill, N.J. Switch 107 performs similar functionality to switch 101, and may or may not be the same type of switch as switch 101.

Subscriber unit 103 is a user of the wireline SMS service provided by communication system 100. An originating subscriber unit sends an SMS message, and a terminating subscriber unit or subscriber units receive the SMS message.

Subscriber units 113 and 114 are connected to switch 101. Subscriber unit 108 is served by switch 107. Subscriber units 103, 113, 114, and 108 are preferably customer premises equipment (CPE), such as a landline telephone, with Caller ID capabilities. Typical subscriber units support fifteen-character MDMF parameters which are displayed, such as a calling name. Potential new CPE or PC applications will support longer messages. A PC application could also be used to send messages and administer lists. Further, some V.92 modems and computer telephony devices have been enhanced include functionality that allows them to receive a sequence of GR30 analog packets. In an exemplary embodiment, modem functionality could be integrated onto the switch.

List/filter user interface 105 provides an interface to subscriber unit 103 for processing SMS lists. Subscriber unit 103 can perform data base (DB) search queries utilizing list/filter user interface 105.

Gatekeeper database 109 stores SMS lists, which may be organized in such a way that the SMS lists can be searched. Gatekeeper database 109 stores and controls buddy lists and information flow to and from subscriber unit 103. Gatekeeper database 109 also controls message lists and information flow to and from subscriber unit 103. Gatekeeper database 109 may optionally be an integral part of switch 101 and/or switch 107.

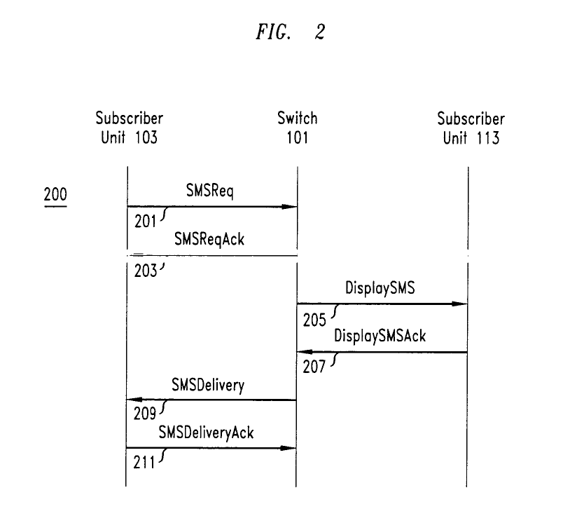

FIG. 2 depicts a call flow diagram 200 in which subscriber unit 103 wants to send a message “No Soccer” to subscriber unit 113. In the exemplary embodiment depicted in FIG. 2, subscriber units 103 and 113 are both subscribed to the wireline SMS service on the same switch, switch 101. Subscriber unit 103 is subscribed to the wireline SMS origination feature, and subscriber unit 113 is subscribed to wireline SMS termination feature.

Wireline SMS groups can include all users on a switch that have subscribed to the wireline SMS feature in the default list, such as for public service announcements. Alternately, wireline SMS groups can be a service-provider administered list. This could either be for a whole business telephone group or for a subscription service list with a restricted set of members, such as a stock quote broadcast. Further, the wireline SMS group can be a user administered list. These user-administered lists would be able to add a user to the list, create a new list, delete an existing list, etc., without telephone service provider interaction.

Subscriber unit 113 preferably includes means for displaying an incoming text message, such as an existing Caller ID display located either internally in the subscriber unit or externally in a separate device, such as a Caller ID device. Alternately, subscriber unit 113 can be a new CPE or a personal computer application, such as e-mail or instant messaging. Further, subscriber unit 113 can include a text-to-voice converter that converts the text message to a voice message for play on a suitable speaker. Alternatively, switch 101 can perform a text-to-speech conversion for subscriber unit 113 if switch translations indicate that is the subscriber's preferred method of message delivery.

Subscriber unit 103 sends SMS request message 201 to switch 101. SMS request message 201 is preferably a preformatted message that includes a text portion, such as “No School”.

SMS request message 201 can alternately be free-form text sent via wireline connection 102. In this embodiment, switch 101 interprets the DTMF digits received, the 0-9, “#“, and “*” keys, as characters or numbers.

In a further alternate embodiment, SMS request message 201 can be text sent via a computer interface. In this embodiment, a computer application formats a send message request to SMS request message 201 and sends SMS request message 201 over line 102 to switch 101.

SMS request message 201 can be encrypted or compressed. For example, SMS request message 201 can be compressed utilizing 6 bit ASCII mapping.

Switch 101 sends SMS request acknowledgment message 203 to subscriber unit 103. SMS request acknowledgment message 203 alerts subscriber unit 103 that switch 101 has received the message properly. SMS request acknowledgment message 203 is preferably a tone or announcement. Alternatively, the acknowledgement could be delivered via SMS.

Switch 101 sends display SMS message 205 to subscriber unit 113. Subscriber unit 113 may include a feature that allows it to deny display of SMS message 205 based on screening the originator's DN or other identifier, the time of day, or SMS message type category.

Subscriber unit 113 sends display SMS acknowledgment message 207 to switch 101 upon receiving display SMS message 205. Display SMS acknowledgment message 207 alerts switch 101 that subscriber unit 113 has received the message properly. In the preferred embodiment, subscriber unit 113 validates message integrity by examining the checksum and notifies switch 101 with a DTMF acknowledgment signal. Alternatively, switch 101 may assume the message was delivered once it has been transmitted without waiting for acknowledgment 207 if switch 101 translations indicate that subscriber unit 113 is not capable of making a response.

Switch 101 sends SMS delivery message 209 to subscriber unit 103. SMS delivery message 209 indicates to subscriber unit 103 that display SMS message 205 has been delivered to subscriber unit 113.

Subscriber unit 103 sends SMS delivery acknowledgment message 211 to switch 101, to acknowledge that it has successfully received SMS delivery message 209.

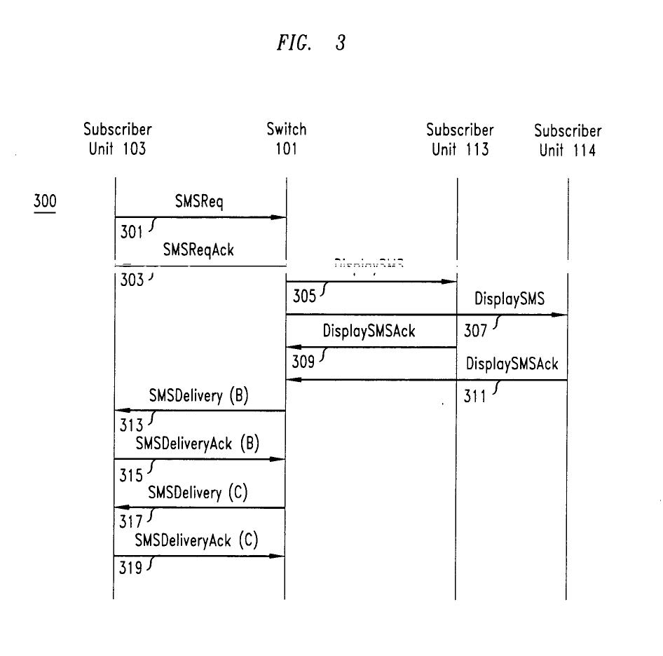

FIG. 3 depicts a call flow diagram 300. In this embodiment, subscriber unit 103 wants to send a message, such as “No Soccer”, to a subscriber list L1. Subscriber list L1 includes subscriber units 113 and 114. In the embodiment depicted in FIG. 3, subscriber units 103, 113, and 114 are all depicted as being subscribed to the wireline SMS service on the same switch, switch 101. Subscriber units 113 and 114 have the wireline SMS termination feature activated.

Subscriber unit 103 sends SMS request message 301 to switch 101. In one exemplary embodiment, subscriber list L1 is part of SMS request message 301. In a further exemplary embodiment, subscriber list L1 is provisioned on switch 101. In this exemplary embodiment, switch 101 is provisioned with the value of L1 that the subscriber unit 103 uses to access the list L1, along with the directory number(s) that are members of L1.

Subscriber units may review or modify subscriber lists stored on switch 101. This can be accomplished via manual modifications via DTMF digits, automated modifications via DTMF digits from a wireline subscriber unit, a Web subscriber programming candidate, or standalone Personal Computer application.

Switch 101 sends SMS request acknowledgment message 303 to subscriber unit 103. SMS request acknowledgment message 303 alerts subscriber unit 103 that switch 101 has received the message properly. SMS request acknowledgment message 303 is preferably a tone or announcement. Alternatively, the acknowledgement could be delivered via SMS.

Switch 101 sends display SMS message 305 to subscriber unit 113. Subscriber unit 113 may include a feature that allows it to deny display of SMS message 305 based on screening the originator's DN or other identifier, the time of day, or SMS message type category.

Switch 101 sends display SMS message 307 to subscriber unit 114. Subscriber unit 114 may include a feature that allows it to deny display of SMS message 307 based on screening the originator's DN or other identifier, the time of day, or SMS message type category.

Subscriber unit 113 sends display SMS acknowledgement message 309 to switch 101 upon receiving display SMS message 305. Display SMS acknowledgment message 309 alerts switch 101 that subscriber unit 113 has received the message properly. In the preferred embodiment, subscriber unit 113 validates message integrity by examining the checksum and notifies switch 101 with a DTMF acknowledgment signal. Alternatively, switch 101 may assume the message was delivered once it has been transmitted without waiting for acknowledgment 309 if switch 101 translations indicate that subscriber unit 113 is not capable of making a response.

Subscriber unit 114 sends display SMS acknowledgement message 311 to switch 101 upon receiving display SMS message 307. Display SMS acknowledgment message 311 alerts switch 101 that subscriber unit 114 has received the message properly. In the preferred embodiment, subscriber unit 114 validates message integrity by examining the checksum and notifies switch 101 with a DTMF acknowledgment signal. Alternatively, switch 101 may assume the message was delivered once it has been transmitted without waiting for acknowledgment 311 if switch 101 translations indicate that subscriber unit 114 is not capable of making a response.

Switch 101 sends SMS delivery message 313 to subscriber unit 103. SMS delivery message 313 indicates to subscriber unit 103 that display SMS message 305 has been delivered to subscriber unit 113.

Subscriber unit 103 sends SMS delivery acknowledgment message 315 to switch 101, to acknowledge that it has successfully received SMS delivery message 313.

Switch 101 sends SMS delivery message 317 to subscriber unit 103. SMS delivery message 317 indicates to subscriber unit 103 that display SMS message 307 has been delivered to subscriber unit 114.

Subscriber unit 103 sends SMS delivery acknowledgment message 319 to switch 101, to acknowledge that it has successfully received SMS delivery message 315.

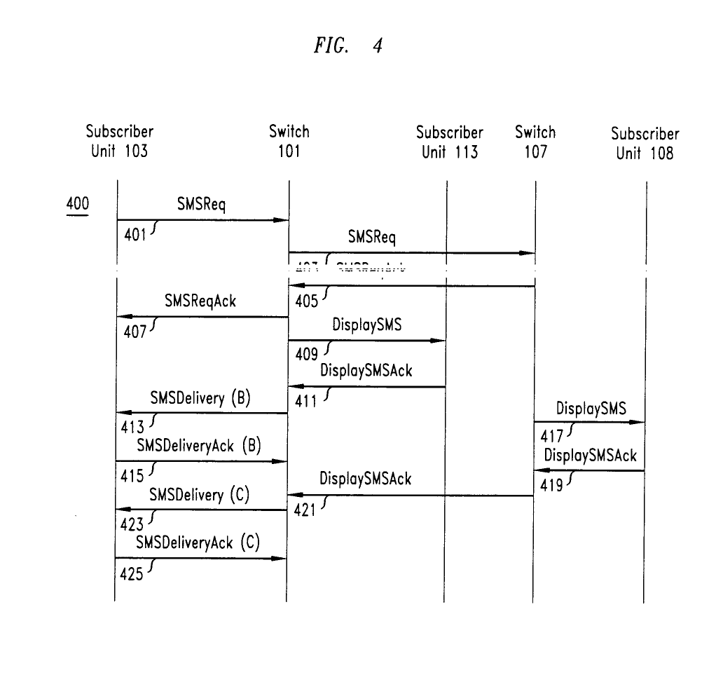

FIG. 4 depicts a call flow diagram 400 in which subscriber unit 103 and subscriber unit 113 are connected to an originating switch 101 and subscriber unit 108 is connected to switch 107. In this embodiment, subscriber unit 103 sends a message “No Soccer” to Subscriber List L1, which includes subscriber unit 113 and subscriber unit 108. Subscriber units 103, 113, and 108 are all subscribed to a wireline SMS feature.

Subscriber unit 103 sends SMS request message 401 to switch 101. SMS request message 401 in this embodiment includes a text portion and a destination of subscriber list L1.

Switch 101 determines the switch associated with each subscriber list L1 member. In the embodiment depicted in FIG. 4, switch 101 will send SMS request message 401 directly to subscriber unit 113 which is homed on switch 101, and will forward SMS request message 401 intended for subscriber unit 108 to the switch associated with subscriber unit 108, switch 107. In an exemplary embodiment, switch 101 sends SMS request messages to each of the subscriber list members by looping through the directory numbers in the subscriber list and sending an SMS request message to each of the subscriber units.

Switch 101 forwards SMS request message 403 to switch 107. Switch 101 preferably utilizes out-of-band signaling to interwork with the SS7 signaling network, such as ISUP (ISDN User Part) and/or TCAP (Transaction Capabilities Application Part), to correspond between switch 101 and switch 107. In the embodiment where subscriber list L1 includes a mobile unit, out-of-band signaling interworks with wireless SMS (Short Message Service, an IS-41 or ETSI GSM standard) to support both text delivery and services. Switch 101 may also support voice-mail notification, presence server implementation, and e-mail interworking.

Switch 107 sends SMS request acknowledgment message 405 to switch 101 to indicate to switch 101 that the message was received at switch 107.

Switch 101 sends SMS request acknowledgment message 407 to subscriber unit 103.

Switch 101 sends display SMS message 409 to subscriber unit 113.

Subscriber unit 113 sends display SMS acknowledgement message 411 to switch 101 to indicate to switch 101 that subscriber unit 113 received SMS message 409 correctly. Error processing or retransmission is optionally done for wireline applications, but acknowledgments are required for wireless applications. Error processing can be accomplished using an external server or utilizing stored messages. Switch 101 preferably does not store or retransmit SMS messages. However, acknowledgement message 411 can indicate that SMS message 409 was not properly received.

Switch 101 sends SMS delivery message 413 to subscriber unit 103.

Subscriber unit 103 sends SMS delivery acknowledgment message 415 to switch 101.

Switch 107 sends display SMS message 417 to subscriber unit 108. Switch 107 determines which subscriber units need to receive display SMS message 417.

It should be understood that switch 107 may forward display SMS message 417 to another switch for that switch to pass the message along to a subscriber unit connected to that switch that is a member of subscriber list L1. It should also be understood that display SMS message 417 may need to be segmented into a group of smaller messages in order to fit within signaling message size limits.

Subscriber unit 108 sends display SMS acknowledgement message 419 to switch 107 to communicate to switch 107 that subscriber unit 108 has properly received display SMS acknowledgement message 419.

Switch 107 forwards display SMS acknowledgement message 421 to switch 101 to alert switch 101 of the status of the delivery of display SMS message 417 to subscriber unit 108.

Switch 101 sends SMS delivery message 423 to subscriber unit 103.

Subscriber unit 103 sends SMS delivery acknowledgment message 425 to switch 101.

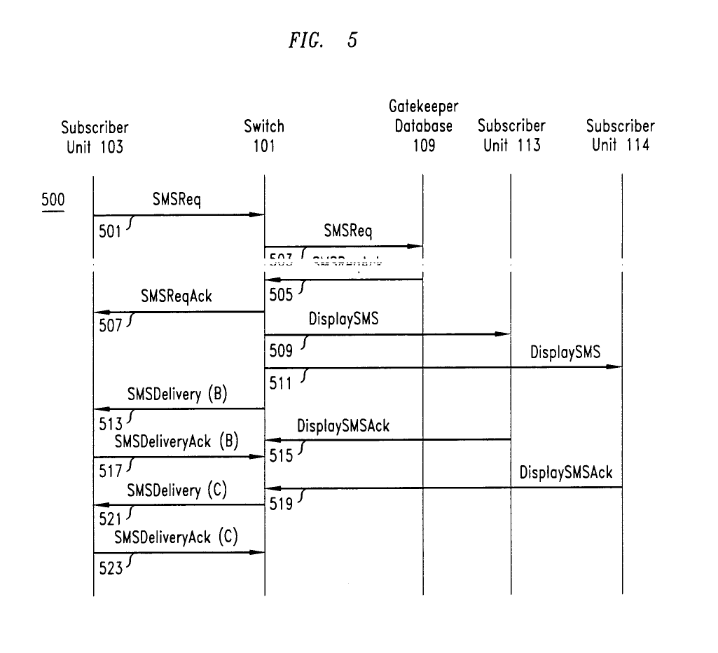

FIG. 5 depicts a call flow diagram 500. In the embodiment depicted in FIG. 5, subscriber unit 103 wants to send a message, such as “No Soccer”, to a subscriber list L1, which includes subscriber units 103, 113, and 114. In the embodiment depicted in FIG. 5, subscriber units 103, 113, and 114 are subscribed to a Wireline SMS service on the same switch, switch 101. In addition, switch 101 does not provision subscriber list L1, but rather gatekeeper database 109 provisions subscriber list L1.

Subscriber unit 103 sends SMS request message 501 to switch 101. SMS request message 501 includes a destination portion and a text portion. In this embodiment, the destination portion of SMS request message 501 includes subscriber list L1, and the text portion includes a message of “No Soccer”. Switch 101 determines the proper action to take with regard to SMS request message 501 based upon the destination portion of SMS request message 501.

Switch 101 sends SMS request message 503 to gatekeeper database 109. For subscriber units provisioned by switch 101, switch 101 will send them a message including at least the text portion of SMS request message 501. For subscriber units that are provisioned by another switch, switch 101 sends a message to that switch to be delivered to the appropriate subscriber units. When switch 101 does not provision subscriber list L1, as depicted in this embodiment, switch 101 sends the message to a gatekeeper database 109 that provisions subscriber list L1.

Gatekeeper database 109 sends SMS request acknowledgment message 505 to switch 101. Gatekeeper database 109 needs to partition subscriber list L1 and send an SMS request message to the proper switches. Gatekeeper database 109 sends a directory number list and the text to switch 101 in SMS request acknowledgment message 505. In the preferred embodiment, gatekeeper database 109 utilizes a directory number (DN)-to-switch mapping. In an alternate embodiment, gatekeeper database 109 utilizes an NPA+NXX-to-Destination Point Code (DPC) mapping. Gatekeeper databases can also be used to support out-of-network Directory Numbers.

In an alternate embodiment of the present invention, gatekeeper database 109 can store text message identifications that correspond to predetermined messages. Gatekeeper database 109 then extracts the identification of a message from SMS request message 503 and determines the message associated with that ID. As an example, SMS request message 503 may include a text portion of “47”. Upon receiving SMS request message 603, gatekeeper database 109 extracts the “47” from SMS request message 503, looks up in a table or the like the message corresponding to “47”, and includes the corresponding message in messages sent to the subscriber units in subscriber list L1. If the message ID for “47? is “No Soccer”, gatekeeper database 109 replaces the “47” with “No Soccer” prior to sending a message to the subscriber units in subscriber list L1.

In a further alternate embodiment of the present invention, gatekeeper database 109 can translate the calling party number and the list ID to DN (directory number) list. Gatekeeper database 109 would get the calling party number and list ID in a message. Gatekeeper database 109 would use those two values (CPN and list ID) as a key to look up a list of directory numbers. Gatekeeper database 109 could either return the list of Directory Numbers or send a message to the Directory Numbers. Gatekeeper database 109 can also translate the calling party number and the text ID to text. Gatekeeper database 109 would get the calling party number and text ID in a message. Gatekeeper database 109 would use those two values (CPN and text ID) as a key to look up a text string. Gatekeeper database 109 could either send the message to the receiver(s) or return just the text string.

In a wireless communication system, gatekeeper database 109 would interwork with a Wireless SMS.

Switch 101 sends SMS request acknowledgment message 507 to subscriber unit 103 to alert subscriber unit 103 that switch 101 has received an acknowledgment from gatekeeper database 109. For wireless applications, acknowledgments are utilized, and for wireline applications acknowledgments may or may not be used. Acknowledgments can be done with either an external server or utilizing stored messages. Switch 101 preferably does not store or retransmit SMS messages. Alternately, SMS request acknowledgment message 507 can indicate that the message was not properly transmitted or received.

Switch 101 sends display SMS message 509 to subscriber unit 113 and display SMS message 511 to subscriber unit 114. Display SMS message 509 and display SMS message 511 each include the text portion of SMS request message 501.

Switch 101 sends SMS delivery message 513 to subscriber unit 103 and SMS delivery message 521 to subscriber unit 103. SMS delivery message 513 and SMS delivery message 521 indicate to subscriber unit 103 that display SMS message 509 and display SMS message 511, respectively, to subscriber unit 113 and subscriber unit 114, respectively.

Subscriber unit 103 sends SMS delivery acknowledgment message 517 to switch 101 to indicate to switch 101 that it has received SMS delivery message 513. Subscriber unit 103 sends SMS delivery acknowledgment message 523 to switch 101 to indicate to switch 101 that it has received SMS delivery message 521.

Subscriber unit 113 sends display SMS acknowledgement message 515 to switch 101 to indicate to switch 101 that it has received display SMS message 509. Subscriber unit 114 sends display SMS acknowledgement message 519 to switch 101 to indicate to switch 101 that it has received display SMS message 515.

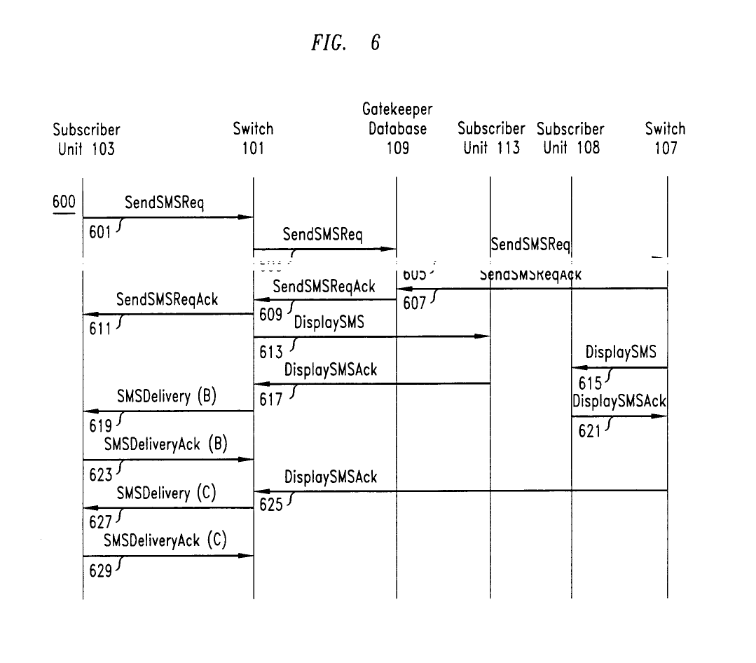

FIG. 6 depicts a call flow diagram 600. In this embodiment, subscriber unit 103 wants to send a message, such as “No Soccer”, to subscriber list L1. Subscriber list L1 includes subscriber unit 113 and subscriber unit 108. Subscriber units 103, 113, and 108 are all subscribed to a wireline SMS service. In the embodiment depicted in FIG. 6, subscriber units 103 and 113 are located on originating switch 101, and subscriber unit 108 is not located on originating switch 101, but rather switch 107. In this embodiment, switch 101 does not provision subscriber list L1, but rather gatekeeper database 109 provisions subscriber list L1.

Subscriber unit 103 sends SMS request message 601 to switch 101. SMS request message 601 includes a destination portion and a text portion. In this embodiment, the destination portion of SMS request message 601 includes subscriber list L1, and the text portion includes a message of “No Soccer”. Switch 101 determines the proper action to take with regard to SMS request message 601 based upon the destination portion of SMS request message 601.

Switch 101 sends SMS request message 603 to gatekeeper database 109. For subscriber units provisioned by switch 101, switch 101 will send them a message including at least the text portion of SMS request message 601. For subscriber units that are provisioned by another switch, switch 101 sends a message to that switch to be delivered to the appropriate subscriber units. When switch 101 does not provision subscriber list L1, as depicted in this embodiment, switch 101 sends the message to a gatekeeper database 109 that provisions subscriber list L1.

Gatekeeper database 109 determines which subscriber units are members of subscriber group L1. In this embodiment, gatekeeper database 109 determines that subscriber unit 113 is provisioned by switch 101, and subscriber unit 108 is provisioned by switch 107. Accordingly, gatekeeper database 109 sends SMS request message 605 to switch 107.

Switch 107 sends SMS request acknowledgment message 607 to gatekeeper database 109. SMS request acknowledgment message 607 communicates to gatekeeper database 109 that switch 107 has received SMS request message 605.

Gatekeeper database 109 sends SMS request acknowledgment message 609 to switch 101. Gatekeeper database 109 needs to partition subscriber list L1 and send an SMS request message to the proper switches. Gatekeeper database 109 sends a directory number list and the text to switch 101 in SMS request acknowledgment message 609. This process is similar to that described with respect to FIG. 5.

Switch 101 sends SMS request acknowledgment message 611 to subscriber unit 103 to alert subscriber unit 103 that switch 101 has received an acknowledgment from gatekeeper database 109. In an exemplary embodiment, acknowledgment messages are utilized in wireless systems. In wireline communication systems, acknowledgment messages are optional. Acknowledgment messages can be accomplished utilizing either an external server or switch-stored messages. Switch 101 preferably does not store or retransmit SMS messages. However, in the situation where a bad acknowledgment message is received, acknowledgment message 611 can also indicate that SMS message 609 was not received properly or were incorrectly transmitted.

Switch 101 sends display SMS message 613 to subscriber unit 113. Display SMS message 613 includes the text portion of SMS request message 601.

Subscriber unit 113 sends display SMS acknowledgement message 617 to switch 101 to indicate to switch 101 that it has received display SMS message 613.

Switch 107 sends display SMS message 615 to subscriber unit 108. Display SMS message 615 includes the text portion of SMS request message 601.

Subscriber unit 108 sends display SMS acknowledgement message 621 to switch 107 to indicate to switch 108 that it has received display SMS message 615.

Switch 107 sends display SMS acknowledgement message 625 to switch 101 to indicate to switch 101 that it has received display SMS acknowledgement message 621 from subscriber unit 108.

Switch 101 sends SMS delivery message 619 to subscriber unit 103 and SMS delivery message 627 to subscriber unit 103. SMS delivery message 619 and SMS delivery message 627 indicate to subscriber unit 103 that display SMS message 613 and display SMS message 615, respectively, to subscriber unit 113 and subscriber unit 108, respectively.

Subscriber unit 103 sends SMS delivery acknowledgment message 623 to switch 101 to indicate to switch 101 that it has received SMS delivery message 619. Subscriber unit 103 sends SMS delivery acknowledgment message 629 to switch 101 to indicate to switch 101 that it has received SMS delivery message 627.

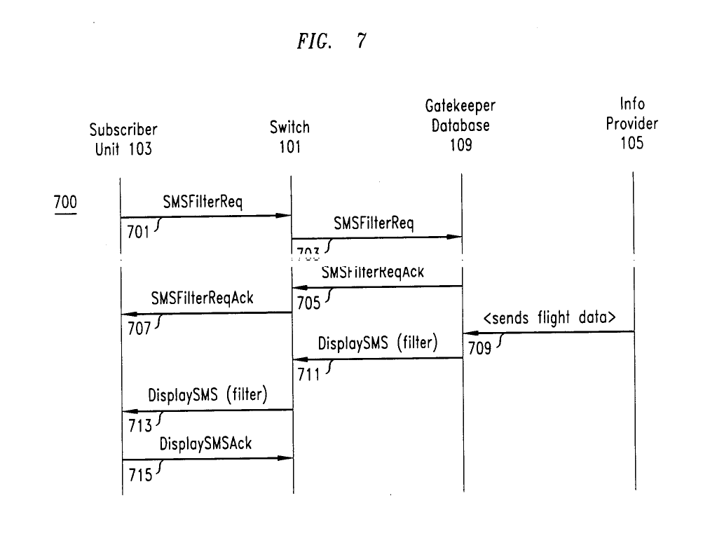

FIG. 7 depicts call flow diagram 700 for a method of providing near real-time filtered information delivery. In this embodiment, subscriber unit 103 sets up a filter, for example for an airline flight such as Flight 111. Information provider 105 uploads status of flights to gatekeeper database 109, including the departure of Flight 111. Updates on the status of Flight 111 are sent to subscriber unit 103.

Subscriber unit 103 sends SMS filter request message 701 to switch 101. SMS filter request message 701 includes filter information for subscriber unit 103. In this embodiment, the filter information relates to the status of a particular airline flight. Switch 101 sends SMS filter request message 703 to gatekeeper database 109. SMS filter request message 703 includes the filter information from SMS filter request message 701.

Gatekeeper database 109 sends SMS filter request acknowledgment message 705 to switch 101.

Switch 101 sends SMS filter request acknowledgment message 707 to subscriber unit 103 to alert subscriber unit 103 that switch 101 has received an acknowledgment from gatekeeper database 109. In wireline communication systems, error processing is optionally done, but for wireless communication systems, error processing is preferably done. Error processing can be accomplished using either an external server or switch-stored messages. Switch 101 does not store or retransmit SMS messages. However, acknowledgment message 707 may indicate that SMS message 703 was not received properly or was incorrectly transmitted.

In the embodiment depicted in FIG. 7, gatekeeper database 109 stores the filters. Alternately, the filters cold be stored by a separate application server. Still further, the filters could be stored by information provider 105. In this embodiment, information provider 105 would send the data, such as flight data, directly to switch 101, which would forward the message to subscriber unit 103 utilizing the Short Message Service.

At this point, the filtered data service has been activated for subscriber unit 103. Depending upon how the filtered data service has been configured, different levels of information can be transmitted to subscriber unit 103 pertaining to the indicated flight, in this case Flight 111.

Information provider 105 sends data message 709 to gatekeeper database 109. Data message 709 includes information pertaining to Flight 111. In an exemplary embodiment, the data format of information at information provider 105 is not specified, but can be, for example, a traditional database dip, XML-based database interface, or web sorts of interfaces such as CGI or some sort of ASCII/HTML parsing technique. Information provider 105 preferably determines that an update has been made by utilizing an interrupt or polling process.

Upon notification of new data from information provider 105, gatekeeper database 109 checks filters to determine if an SMS message needs to be sent to any subscriber units. In the embodiment depicted in FIG. 7, data message 709 includes information about Flight 111, which subscriber unit 103 has indicated, in SMS filter request message 701, that it is interested in. Consequently, gatekeeper database 109 will send this information to subscriber unit 109 via switch 101. In an alternate embodiment, if information provider 105 was performing the filtering, it would make the determination that information pertaining to Flight 111 needed to be sent to subscriber unit 103, and would send an SMS message including the information to switch 101, which would forward the message to subscriber unit 103.

Returning to the embodiment depicted in FIG. 7, upon receiving data message 709 and determining that a message should be sent to subscriber unit 103, gatekeeper database 109 sends display SMS filter message 711 to switch 101. Display SMS filter message 711 preferably includes a filter tag set within the message. The filter tag indicates that no acknowledgment is needed from subscriber unit 103.

Switch 101 forwards display SMS filter message 713 to subscriber unit 103. Display SMS filter message 713 includes the information related to Flight 111 as sent by information provider 105.

Subscriber unit 103 sends display SMS filter acknowledgement message 715 to switch 101 to indicate to switch 101 that it has received display SMS filter message 713.

It should be understood that information provider 105 can continue to send messages relating to Flight 111 to subscriber unit 103 indefinitely, for a predetermined amount of time, for a predetermined number of messages, or for specific predetermined events. Subscriber unit 103 can cancel the service, preferably by sending a message to gatekeeper database 109 via switch 101.

Alternately, subscriber unit 103 can signify, in SMS filter request message 701, the trigger that will terminate the sending of filtered messages to subscriber unit 103 relating to the event specified in SMS filter request message 701. For example, subscriber unit 103 may want to receive a single message relating to Flight 111, such as when it departs. Upon departure, the filtered message process is cancelled. In a further exemplary embodiment, subscriber unit 103 may only be interested in the landing of Flight 111, or may only desire to receive messages relating to Flight 111 during a specified period of time. Once this time expires, subscriber unit 103 is no longer interested in receiving information about Flight 111.

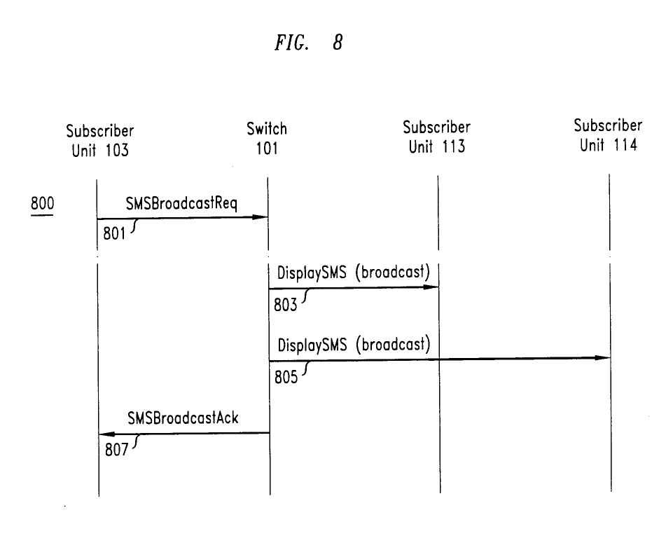

FIG. 8 depicts a call flow diagram 800. In this embodiment, subscriber unit 103 wants to send a broadcast message, such as “Washington School is closed today”, to all subscriber units that subscribe to the Wireline SMS Terminating feature on the switch. Call flow diagram 800 depicts a best-effort method for sending broadcast information to a group of users. In the embodiment depicted in FIG. 8, subscriber units 103, 113, and 114 are all depicted as being subscribed to the Wireline SMS Terminating feature on the switch, switch 101. Subscriber units 113 and 114 have the wireline SMS termination feature activated. It should be understood that this embodiment can be practiced using a plurality of switches and a plurality of subscriber units, but only one such switch is depicted in FIG. 8 for clarity.

Subscriber unit 103 sends SMS broadcast request message 801 to switch 101. SMS broadcast request message 801 preferably includes an originator portion, a text portion, and a destination portion. The text portion of SMS broadcast request message 801 may be limited to a predetermined size since it is being broadcast to a plurality of subscriber units.

Switch 101 sends display SMS broadcast message 803 to subscriber unit 113. In a preferred embodiment of the present invention, switch 101 has a list of directory numbers that are allowed to send a broadcast message. Switch 101 checks the originating directory number against the allowable list to determine whether switch 101 will broadcast the received message.

Switch 101 sends display SMS broadcast message 805 to subscriber unit 114. Switch 101 will send a display SMS broadcast message to all users who are subscribed to the wireline SMS terminating feature.

Subscriber units 113 and 114 may include privacy controls which disallow certain messages from being displayed at subscriber unit 113 and 114. In the preferred embodiment of the present invention, the text portion of display SMS broadcast message 803 and display SMS broadcast message 805 will be displayed in the receiving subscriber units, even if the subscriber unit includes privacy controls.

Switch 101 sends SMS broadcast acknowledgment message 807 to subscriber unit 103. SMS broadcast acknowledgment message 807 indicates that SMS broadcast request message 801 has been sent to all subscriber units subscribed to the Wireline SMS Terminating feature on switch 101. In the exemplary embodiment depicted in FIG. 8, SMS broadcast acknowledgment message 807 indicates that SMS broadcast request message 801 has been sent, but not necessarily that it has been received by all subscriber units. In this embodiment, the subscriber units are assumed to buffer messages, so the chances of a subscriber unit missing a message is minimized, even without the utilization of acknowledgment messages. Eliminating acknowledgment messages in this exemplary embodiment is desirable since the conditions that triggered the sending of the broadcast message, such as bad weather conditions, would very likely cause other institutions to send a similar message. By eliminating acknowledgment messages, network traffic is minimized at a time when bandwidth is needed.

While this invention has been described in terms of certain examples thereof, it is not intended that it be limited to the above description, but rather only to the extent set forth in the claims that follow.

We claim:

1. A method for sending a short message from a first wireline phone to a second wireline phone comprising:
sending an SMS (Short Message Service) message from the first wireline phone to a switch; and
sending the SMS message from the switch to the second wireline phone.

2. A method for sending a short message from a first wireline phone to a second wireline phone in accordance with claim 1, the method further comprising the step of denying the SMS message at the second wireline phone.

3. A method for sending a short message from a first wireline phone to a second wireline phone in accordance with claim 1, the method further comprising the step of displaying the SMS message on a caller ID display

4. A method for sending a short message from a first wireline phone to a second wireline phone in accordance with claim 2, the method further comprising the step of converting the SMS message to a voice message.

5. A method for sending a short message from a first wireline phone to a second wireline phone in accordance with claim 1, wherein the step of sending an SMS message from the first wireline phone to a switch comprises sending a preformatted message from the first wireline phone to the switch.

6. A method for sending a short message from a first wireline phone to a second wireline phone in accordance with claim 1, the method further comprising the step of interworking with a wireless SMS.

7. A method for sending a short message from a wireline phone to an information provider comprising:
sending an SMS (Short Message Service) message from the wireline phone to a switch;
sending the SMS message from the switch to the information provider; and
sending near real-time filtered information from the information provider to the wireless phone.

8. A method for sending a message from a first wireline phone to a wireline SMS group, the wireline SMS group comprising a plurality of wireline phones, the method comprising:
sending a group SMS message for the wireline SMS group from the first wireline phone to a switch; and
sending the group SMS message from the switch to each of the plurality of wireline phones that are members of the wireline SMS group.

9. A method for sending a message from a first wireline phone to a wireline SMS group in accordance with claim 8, wherein the step of sending a group SMS message for the wireline SMS group from the first wireline phone to a switch comprises sending a group SMS message comprising a list sent in the signaling message.

10. A method for sending a message from a first wireline phone to a wireline SMS group in accordance with claim 8, wherein the wireline SMS group comprises a list provisioned on the switch.

11. A method for sending a message from a first wireline phone to a wireline SMS group in accordance with claim 10, wherein the wireline SMS group is associated with a directory number.

12. A method for sending a message from a first wireline phone to a wireline SMS group in accordance with claim 8, wherein the step of sending the group SMS message from the switch to each of the plurality of wireline phones comprises:
sending the group SMS message from the switch to a first wireline phone; and
sending the group SMS message from the switch to a second wireline phone via a second switch.

13. A method for sending a message from a first wireline phone to a wireline SMS group in accordance with claim 8, the method further comprising the step of providing voice mail notification at at least one of the plurality of wireline phones that are members of the wireline SMS group.

14. A method for sending a message from a first wireline phone to a wireline SMS group in accordance with claim 8, the method further comprising the step of providing e-mail interworking at at least one of the plurality of wireline phones that are members of the wireline SMS group.

15. A method for sending a message from a first wireline phone to a wireline SMS group in accordance with claim 8, the method further comprising the step of, at the second switch, determining which phones should receive the group SMS message.

16. A method for sending a message from a first wireline phone to a wireline SMS group in accordance with claim 15, the method further comprising the step of forwarding the group SMS message from the second switch to the second wireline phone.

17. A method for sending a message from a first wireline-phone to a wireline SMS group in accordance with claim 8, wherein the step of sending the group SMS message from the switch to a first wireline phone comprises sending the group SMS message via a plurality of segmented messages.

18. A method for sending a message from a first wireline phone to a wireline SMS group, the wireline SMS group comprising a plurality of wireline phones, the method comprising:
sending a group SMS message for the wireline SMS group from the first wireline phone to a gatekeeper database;
determining at the gatekeeper database the directory number of each of the phones in the wireline SMS group; and
sending the group SMS message from the gatekeeper database to the phones in the wireline SMS group.

19. A method for sending a message from a first wireline phone to a wireline SMS group in accordance with claim 18, wherein the step of determining at the gatekeeper database the directory number of each of the phones in the wireline SMS group comprises determining the location utilizing directory number to switch mapping.
